(19) United States
(12) Patent Application Publication
(10) Pub. No.: US 2025/0302085 A1
(43) Pub. Date: Oct. 2, 2025

(54) DIE FOR EXTRUDING A MATERIAL RICH IN PROTEINS AND WATER, AND SYSTEM FOR CONTINUOUSLY PREPARING AN EXTRUDED FOOD PRODUCT, COMPRISING SUCH A DIE

(71) Applicant: CLEXTRAL, FIRMINY (FR)

(72) Inventors: Jérôme MOTTAZ, SAINT-MAURICE DE LIGNON (FR); Nadège VARNIER, SAINTE-SIGOLENE (FR); Damien CIZERON, Sorbiers (FR); Laurent GUIMET, ROCHE-LA-MOLIERE (FR)

(21) Appl. No.: 19/092,306

(22) Filed: Mar. 27, 2025

(30) Foreign Application Priority Data
Mar. 27, 2024 (FR) 2403105

(51) Int. Cl. A23P 30/20; A23J 3/26

(52) U.S. Cl. CPC A23P 30/20; A23J 3/26

(57) ABSTRACT

A tubular casing centered on an axis and a coaxial core mounted rotatably about the axis. An upstream part of the core extends into the casing so that a material flow channel is defined therebetween, which is annular in cross-section and centered on the axis. A downstream part of the core extends outside the casing and is coupled to a motor-drive for driving in rotation is fixedly secured to the casing and coaxially received in the casing so that a passage is delimited therebetween, connecting a central inlet of the casing and an upstream end of the channel. The passage is shaped so that the material advances through the passage forming a flow that diverges from the axis toward the downstream and is distributed around the axis. The male divergent part abuts axially against the upstream part of the core, supporting same and guiding same in rotation.

### CROSS REFERENCE TO RELATED APPLICATIONS

The application claims priority to and the benefit of French Patent Application No. FR2403105 filed on Mar. 27, 2024, which is incorporated by reference in its entirety.

### BACKGROUND

The present invention relates to a die for extruding a material high in protein and water. The invention further relates to a system for the continuous preparation of an extruded food product, comprising such an extrusion die.

The invention relates to extrusion equipment for forcing a material, driven in an extruder sleeve by one or a plurality of screws, in particular two screws, driven in rotation about themselves, to flow through an extrusion die, provided at the downstream end of the extruder sleeve. The screws and the extrusion sleeve typically belong to an extruder for applying a thermo-mechanical processing to the material, in the sense that the material undergoes both an essentially mechanical transformation, through pressurization and through shearing by the screws, and an essentially heat transformation, through temperature regulation along the extruder sleeve. The extrusion die can then be used to shape, texture and/or fiber the extruded material.

More specifically, the invention relates to the extrusion of materials high in proteins and in water, and to the associated systems for continuously preparing an extruded food product from a raw material high in proteins and in water. The proteins of the raw material can be of animal and/or plant origin and/or of another origin. In all cases, the proteins are mixed with a large proportion of water, as well as, if appropriate, fats and additives, and the corresponding mixture is subject to the thermo-mechanical processing applied by the extruder in order to be heated and gelled before being shaped in the die. The texturization, otherwise called fibration, of a food product essentially takes place in the die through which the material coming out of the extruder sleeve passes, being pushed by the screws of the extruder. [In French], the method for preparing food products based on fiberized proteins is known under the name “CEMH” which is the acronym of the French expression “Cuisson-Extrusion en Milieu Humide” [Extrusion-cooking in a humid medium], as well as under the name “HME” which is the acronym of the English expression “High Moisture Extrusion”.

WO 03/007729 discloses a CEMH method and an associated extrusion material, wherein a die is designed for cooling in a controlled manner the material flowing through, by making the material flow through a channel which has both a great length, typically of several meters, and a rectangular cross-section, a temperature profile being applied along the channel so as to gradually decrease the temperature of the material between the inlet and the outlet of the channel. The material in contact with the cooled wall of the channel tends to adhere to said wall, thereby shearing the laminar flow of material in the channel. The shearing contributes to the development of current lines within the material paste and tends to align denatured macromolecules along the direction of flow. In practice, the shear rate and the flow regime result from the fixed geometry of the channel, so that the control of the fibration requires that the channel and, thereby, the processing time in the die, be long.

On the same principle, WO 2019/158605 discloses an extrusion die of tubular shape, wherein the material flows in the form of an annular flow which, along the peripheral direction thereof, is interrupted in a lower portion by a support part of the die. The die is arranged at the downstream end of an extruder at the outlet of which a flow of cylindrical material is made annular by the die in order to form the aforementioned annular flow. To this end, the die includes, at the inlet, a divergent cone-shaped part, the tip of which is centered and turned on the outlet of the extruder. The shear applied to the flow of annular material in the die is similar to same described in WO 03/007729. The corresponding annular channel of the die is thus also long.

WO 2022/018084 and WO 2023/006713 propose an alternative approach, by providing for the die thereof to include a core mounted in rotation on itself in a coaxial tubular casing, while delimiting, between the rotating core and the stationary casing, an annular channel through which the material flows to pass through the die. The dies serve for very efficient fibration in the sense that the material flowing through the annular channel of the die is subjected to two combined movements, namely that the material is pushed along the axis of the die by the screws of an extruder at the outlet of which the die is arranged, and that the material is sheared at the periphery by the rotation of the rotating core. The degree of fibration of the material is adjustable in particular by adjusting the speed with which the rotating core is driven.

The dies proposed in WO 2022/018084 and WO 2023/006713 are thus particularly interesting, but induce mechanical stresses for some of the components thereof. Indeed, at the inlet of the die, the cylindrical flow of material pushed by the extruder is made annular by a cone integrated at the upstream end of the rotating core: the hydrostatic axial thrust forces applied to the cone by the material leaving the extruder are thus substantial and are transmitted directly to the rest of the rotating core which must then be blocked axially accordingly, typically by ball stops. The axial forces are taken up by a bearing structure of the die, which is at risk of being locally deformed, unless same is dimensioned accordingly, or even attached to the ground, and with the disadvantage of making the bearing structure difficult to move and hence not very practical. Moreover, although the downstream part of the rotating core, arranged outside the stationary casing, is supported and guided in rotation, the rotating core tends, by its own weight and its length, to bend at the upstream part thereof, in other words at the aforementioned cone and of the annular channel between the casing and the upstream part of the rotating core, which can induce a defect in coaxiality between the latter and, thereby, a degradation of the setting of the fibration of the material passing through the die.

### BRIEF SUMMARY

The goal of the present invention is to propose an extrusion die with a rotating core, which would be more compact and would have higher performance.

To this effect, the subject matter of the invention is a die for extruding a material high in protein and in water, including:
a casing, which is tubular, centered on an axis, and which is provided with a central inlet through which material enters the interior of the casing to be pushed through the die, and
a core, which is coaxial with the casing and mounted rotatably about the axis relative to the casing,
wherein the core includes an upstream part extending at least partially within the casing such that between an inner surface of the casing and an outer surface of the core, a channel is delimited, having a cross-section which is annular and centered on the axis, which channel includes an upstream end and a downstream end which are axially opposed to each other and between which material pushed through the die flows into the channel from the upstream end to the downstream end of the channel, and
wherein the core also includes a downstream part, extending outwardly from the casing and coupled to a die motor-drive, suitable for driving the core in rotation about the axis,
wherein the die further includes a male divergent part which is: fixedly secured to the casing and coaxially received inside the casing in such a way that, between the male divergent part and the casing, a passage is delimited, through which the central inlet of the casing and the upstream end of the channel are connected and which is shaped in such a way that the material pushed through the die advances into the passage, from the central inlet of the casing toward the upstream end of the channel, forming a flow of material which diverges from the axis toward the downstream and is distributed around the axis, and
abutted axially to the upstream part of the core, supporting and guiding the core in rotation.

By means of the invention, a flow of cylindrical material, entering the die, is made annular by the male divergent, by applying to the latter hydrostatic thrust forces which are not taken up by the rotating core, but by the casing of the die. The dimensioning of the fixed securing between the male divergent part and the casing is easy, by means of a simple calculation of static mechanics, and all the mechanical stresses resulting from the hydrostatic thrust stay localized in a well-circumscribed region of the die. The possible deformations induced by the mechanical stresses also stay local, in particular without significant impact on a bearing structure of the die, the bearing structure thereby being easily arranged to be mobile on the ground, e.g. by means of rollers. More particularly, no hydrostatic thrust force is transmitted to the bearing structure via the rotating core, which prevents having to stiffen the part of the bearing structure which axially holds the rotating core, typically at the downstream part of the latter. At the same time, the male diverging part has a function of supporting and guiding the rotating core in rotation, cooperating for this purpose with the upstream part of the rotating core, outside the flow of the material through the die. An excellent control over the coaxiality between the rotating core and the casing results therefrom and, thereby, an excellent control over the conditions of fibration of the material passing through the die according to the invention. The performance and practicality of the die according to the invention are thereby remarkable.

According to advantageous additional features of the die according to the invention, taken individually or according to all technically possible combinations:

The male divergent part delimits an internal housing, which is separated from the passage and wherein the upstream part of the core is received while being supported and guided in rotation.

The die further includes a bearing, which is centered on the axis and which is radially interposed between the upstream part of the core and a wall of the male divergent part, delimiting the internal housing.

The passage is delimited by an outer surface of the male divergent part, which is conical, centered on the axis and diverging downstream.

The casing comprises a die sleeve, which delimits the said inner surface of the casing, and wherein the casing also includes a female diverging part (i) which is fixedly secured to the die sleeve, (ii) which is provided with the central inlet of the casing, and (iii) inside which the male divergent part is arranged coaxially so as to delimit the passage between the female divergent part and the male divergent part.

The male divergent part is fixedly secured to the casing by respective parts of the male divergent part and of the casing, one and/or the other of which are perforated in order to be crossed by said flow of material.

The male divergent part includes a peripheral flange (i) by which the male divergent part is fixedly secured to the casing, (ii) which extends transversely to the axis across said flow of material, and (iii) through which extends the passage via apertures in the peripheral flange, which are distributed around the axis and through which said flow of material crosses the peripheral flange.

The peripheral flange is axially caught between the die sleeve and the female divergent part of the casing.

The die further includes a sealing member that is designed to seal a mechanical rotating uncoupling interface between the male divergent part and the core.

The sealing member is (i) received in a peripheral groove of the upstream part of the core, and (ii) applied radially against a ring of the male divergent part, the ring having an outer surface which is flush with said outer surface of the upstream part of the core.

A further subject matter of the invention is a system for the continuous preparation of an extruded food product, comprising:
a raw material that is rich in proteins and in water,
an extruder including at least one screw and an extruder sleeve inside which the at least one screw can be rotated so as to apply a thermomechanical processing to the raw material, and
a die, which is as defined above and the casing of which is fixedly secured to the extruder sleeve in such a way that, at the outlet of the extruder sleeve, the material is pushed by said at least one screw through the die via the central inlet of the casing.

### BRIEF DESCRIPTION OF THE DRAWINGS

The invention will be better understood upon reading the following description, given only as an example and making reference to the drawings, wherein:

FIG. 1 is a partially schematic perspective view of a system according to the invention;

FIG. 2 is a partially schematic section of part of the system shown in FIG. 1 according to plane II of FIG. 1;

FIG. 3 is a view on a greater scale of the boxed zone Ill shown in FIG. 2;

FIGS. 4 and 5 are perspective views, at different respective observation angles, of a male divergent part belonging to the system shown in FIG. 1; and

FIG. 6 is a view on a greater scale of a boxed zone VI shown in FIG. 3.

### DETAILED DESCRIPTION

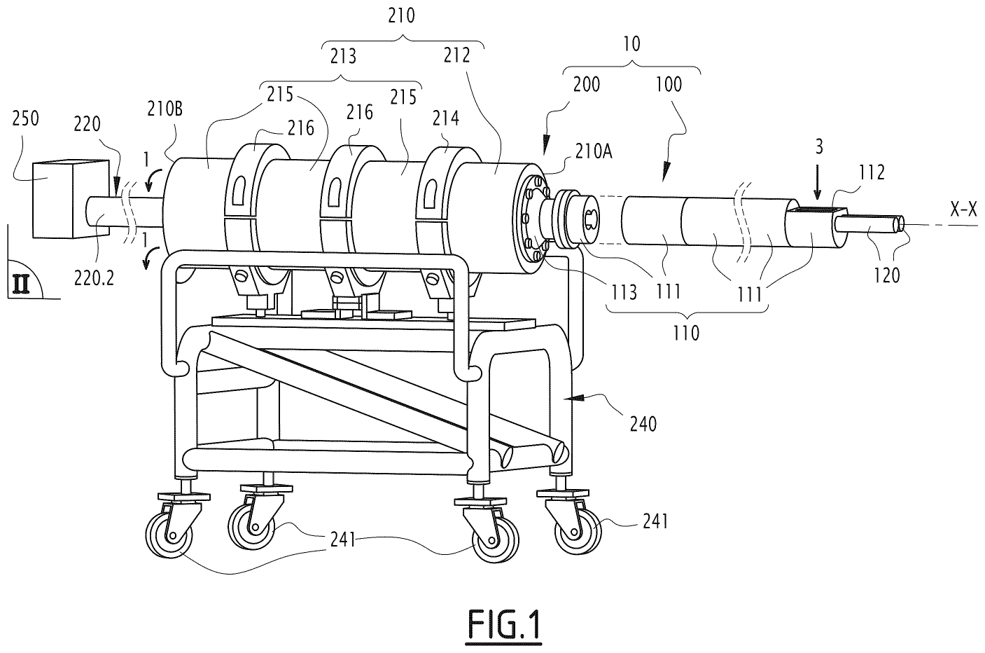

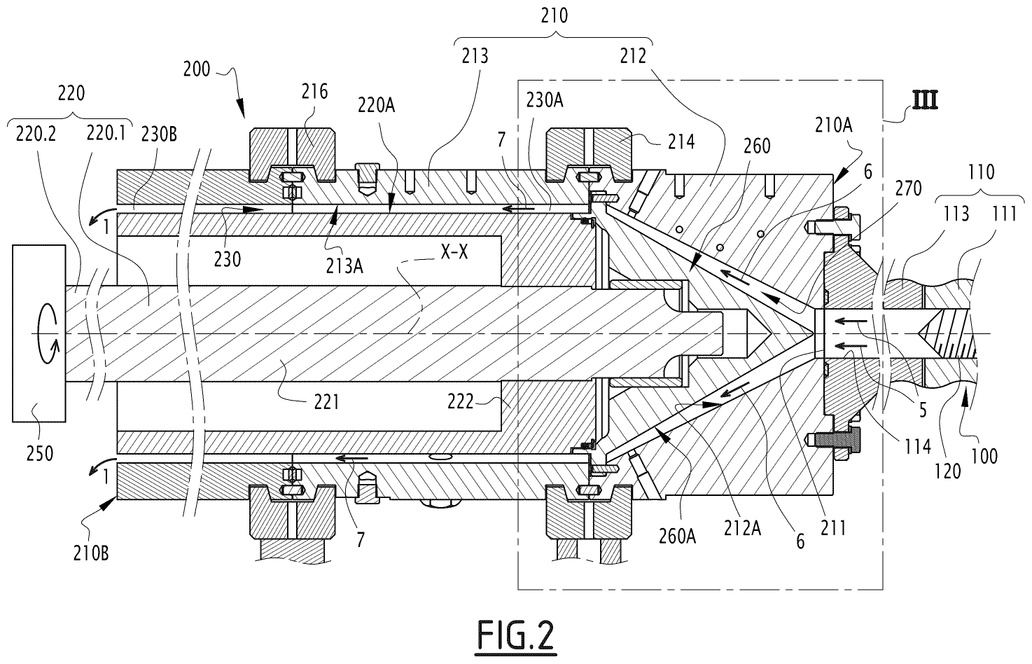

FIGS. 1 and 2 schematically show a system for continuously preparing, by extrusion, a food product 1 intended for human and/or animal consumption. The system mainly includes a raw material 3 and an extrusion machine 10, which will be discussed in detail a little further down.

The raw material 3 is rich in proteins and in water. More precisely, the raw material 3, i.e. all the ingredients which are processed by the extrusion machine 10 to form the food product 1, contain predominantly, in other words more than 50% by weight, of water and proteins, as well as, to a minor or even marginal extent, dietary fibers and/or starch, and possibly fats and additives.

The food product 1, as is obtained at the outlet of the extrusion machine 10, is textured, in other words fiberized. The food product 1 comprises between 25 and 90% by weight, preferably between 50 and 85% by weight, of water and also comprises, by weight, between 20 and 90% of proteins over the entire dry material.

The proteins of the raw material 3 and hence of the food product 1 are of plant and/or animal origin and/or at least of one other origin. Plant proteins come e.g. from legumes, cereals and/or protein crops (soy, wheat, peas, corn, chickpeas, lentils, etc.). Proteins of animal origin are derived e.g. from fish, meat, milk and/or eggs. The other origin or origins of proteins are e.g. mushrooms, algae, insects, cellular meat, etc.

The food product 1 further comprises, by weight over the total dry matter, between 0 and 50% of dietary fibers and between 0 and 50% of starch, the sum of the dietary fibers and/or starch being preferentially greater than 0.01%. Dietary fibers are e.g. fibers of plant origin and starch e.g. is of plant origin, in the native, pregelled or modified state.

The food product 1 can also comprise, by weight over the entire dry matter, between 0 and 20% fats, in particular of plant and/or animal origin, and/or functional ingredients, such as lecithins, caseinates or other ingredients.

As can be seen clearly in FIGS. 1 and 2, the extrusion machine 10 mainly includes an extruder 100 and a die 200 which will be described in detail thereafter.

As is schematically shown in FIG. 1, the extruder 100 comprises a sleeve 110 with an elongated shape, which extends along a geometric axis X-X and which is centered on the axis. Inside the sleeve 110, two screws 120 extend parallel to the axis X-X, being received in a central longitudinal bore of the sleeve, centered on the axis X-X. In practice, in a manner known per se, each screw 120 includes e.g. a central screw shaft on which a set of screw elements is mounted. In any case, the two screws 120 extend herein on both sides of the axis X-X, while being interpenetrating, the bore of the sleeve 110 thereby having a two-lobe transverse profile.

The screws 120 are designed for being rotated on themselves, about the central axis thereof, by a drive unit, not shown in the figures, engaged with the upstream end of the screws 120, namely the right-hand end in FIG. 1, emerging outside the sleeve 110.

The screws 120 are designed, due to the threaded profile thereof, for pulling along the raw material 3 inside the sleeve 110 along the axis X-X, from an upstream part of the sleeve 110, into which the ingredients of the raw material 3 are inserted inside the central longitudinal bore of the sleeve 110, as far as the downstream end of the sleeve 110, the terms “upstream” and “downstream” being oriented along the direction of progression of the material inside the extrusion machine 10 under the action of the screws 120, the direction of progression being from right to left in FIGS. 1 to 3 and 6.

In practice, the sleeve 110 includes a plurality of modular elements 111 which, as schematically shown in FIG. 1, follow one another along the axis X-X. Each of the modular elements 111 internally delimits a corresponding part of the central longitudinal bore of the sleeve 110, the bore parts being in line with one another, along the axis X-X, in the assembled state of the modular elements 111, as in the FIG. 1. In FIG. 1, the modular element which is furthest downstream among the modular elements 111 is only partially shown, which makes it possible to observe the corresponding part of the bore, it being noted that, for better visibility, the screws 120 are also not shown in said part of the bore.

In the example of embodiment considered in the figures, the modular element of the sleeve 110, furthest upstream among the modular elements 111 can be used for inserting, inside the bore part thereof, the ingredients of the raw 3 material. To this end, in a manner known per se and not presented in detail herein, the modular element furthest upstream is provided with a hole 112 which, transversely to the axis X-X, opens to the outside, herein upwards, the bore part of the modular element which is furthest upstream. More generally, it is understood that, among the different modular elements 111 of the sleeve 110, one or a plurality of the elements make it possible to insert, inside the central longitudinal bore of the sleeve 110, the solid and/or liquid ingredients of the raw material 3 to be processed by the extrusion machine 10.

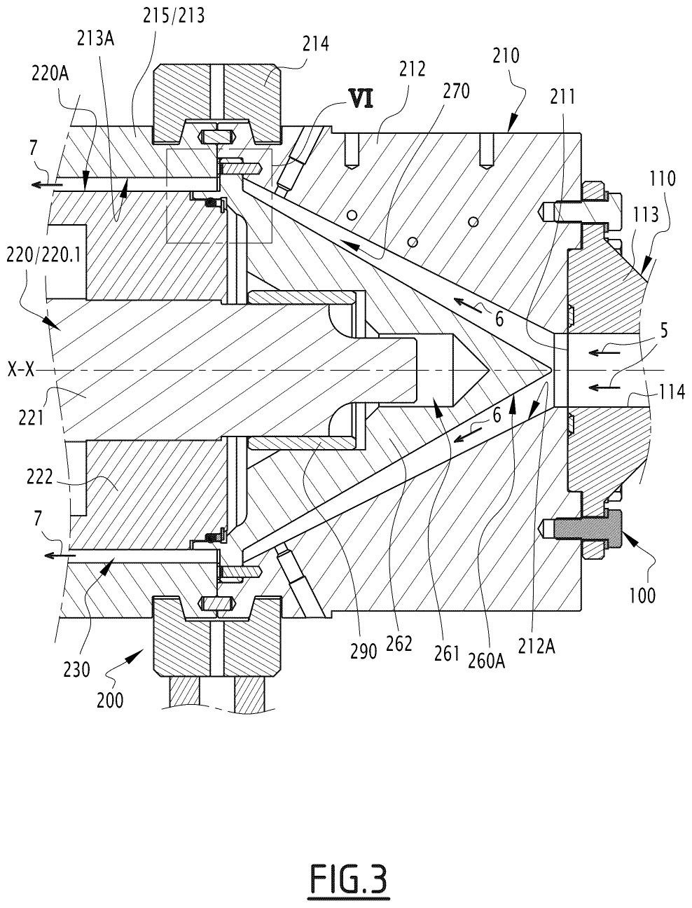

As mentioned in the introductory part of the present document, the screws 120 are designed, in addition to pulling along the material to be extruded, for shearing and pressurizing the raw material 3, so as to transform same in an essentially mechanical way. Since such aspect of the extruder 100 is well known in the field, same will not be further discussed herein. Similarly, also as mentioned in the introductory part, the sleeve 110 is advantageously designed for regulating the temperature of the material to be extruded along the sleeve 110 so as to transform the material in an essentially thermal way. To this end, all or part of the modular elements 111 of the sleeve 110 are thermoregulated and/or allow steam to be injected into the sleeve 110 and/or allow the material being extruded into the sleeve 110 to be degassed. Herein again, such aspect of the extruder 100 being well known in the field, same will not be described hereinafter. More generally, the sleeve 110 and the screws 120 are designed for applying a thermomechanical processing to the raw material 3 as said material advances from the upstream end of the sleeve 110 to the downstream end of the sleeve 110. The material resulting from the thermomechanical processing and leaving the sleeve 110 is referenced 5 in FIGS. 2 and 3.

At the downstream end thereof, the sleeve 110 advantageously comprises an end element 113, commonly called the “front plate” in the field. The end element 113 is directly mounted in a fixed manner to the rest of the sleeve 110, herein at the downstream end of the modular element furthest downstream, among the modular elements 111 of the sleeve 110. As can be seen clearly in FIGS. 2 and 3, the end element 113 internally defines a through bore 114 which is centered on the axis X-X, and which forms a downstream end part of the central longitudinal bore of the sleeve 110, receiving, where appropriate, the downstream end of the screws 120. Herein, the bore 114 of the end element 113 extends in the axial continuation of the bore part of the most downstream modular element among the modular elements 111. The bore 114 is suitable for channeling the material 5 pushed downstream by the screws 120 so as to provide appropriate pressurization and filling ratio for the central longitudinal bore of the sleeve 110. For this purpose, the bore 114 is e.g. at least partially chocked toward the downstream, herein in a plane perpendicular to the plane of FIGS. 2 and 3, and/or provided with a transverse grid, herein not shown in the figures. Since such aspect of the extruder 100 does not limit the scope of the invention, such aspect will not be described hereinafter.

By focusing more specifically on the die 200, the die 200 is designed to let through the material 5 for the purpose of extruding the latter. In the assembled state of the extrusion machine 10, the die 200 is arranged at the downstream end of the sleeve 110 of the extruder 100 so that the material 5 leaving the sleeve 110 is forced, under the action of the screws 120 of the extruder 100, to flow through the die 200.

As can be seen in FIGS. 1 to 3, the die 200 includes an outer casing 210 which is tubular, being centered on a geometric axis which, in the assembled state of the extrusion machine 10, coincides with the axis X-X and which will hence be considered thereafter as being the axis X-X. The casing 210 thereby has two opposite ends along the axis X-X, namely an upstream end 210A and a downstream end 210B. The casing 210 delimits an internal volume which, due to the tubular shape of the casing 210, is essentially closed all around the axis X-X by the casing 210, while coming out axially onto the outside of the casing 210 at the upstream end 210A and downstream end 210B of the latter.

In the assembled state of the extrusion machine 10, the sleeve 110 of the extruder 100 and the casing 210 of FIG. 200 are fixedly secured to each other. In practice, the outer casing 210, in particular the upstream end 210A thereof, is for such purpose fixedly secured, either directly or indirectly, to a downstream part of the sleeve 110, in particular to the end element 113 of said sleeve.

At the upstream end 210A thereof, the casing 210 is provided with a central inlet 211, which is centered on the axis X-X and through which the axis X-X passes. The central inlet 211 connects the internal volume of the casing 210 with the outside of the casing 210. In the assembled state of the extrusion machine 10, the material 5 pushed by the screws 120 of the extruder 100 enters the internal volume of the casing 210 via the central inlet 211 in order to be pushed through the die 200: in the embodiment considered herein, the central inlet 211 is abutted against the bore 114 of the end element 113 of the sleeve 110, more precisely at the downstream end of the bore 114, in order to allow the material 5 to flow between the bore 114 and the central inlet 211. In practice, the cross-section of the central inlet 211, i.e. the cross-section of the latter in a plane perpendicular to the axis X-X, is advantageously adjusted to that of the downstream end of the central longitudinal bore of the sleeve 110, herein to same of the downstream end of the bore 114, in particular to limit the head losses and the disturbances in the flow of the material. Preferentially, the cross-section of the central inlet 211 has a circular contour centered on the axis X-X.

In the embodiment considered in the figures, the casing 210 comprises a female divergent part 212 and a sleeve 213, which follow one another along the axis X-X, the sleeve 213 being arranged downstream of the female divergent part 212, as clearly visible in FIGS. 1 to 3. The female divergent part 212 and the sleeve 213 each have a tubular shape, in the sense that same delimit respective internal volumes corresponding to sub-volumes, respectively, of the internal volume of the casing 210. The female divergent part 212 and the sleeve 213 are fixedly secured to each other, herein by a fastening collar 214.

The female divergent part 212 has the upstream end 210A of the casing 210, being provided with the central inlet 211. Herein, in the assembled state of the extrusion machine 10, the end element 113 of the sleeve 110 of the extruder 100 is secured to the casing 210 of the die 200 by means of the female divergent part 212, the end element 113 being e.g. bolted to the female divergent part 212.

In any case, the female divergent part 212 delimits an inner surface 212A which closes the internal volume of the female divergent part 212 all around the axis X-X and by which the central inlet 211 is connected along the axis X-X with the internal volume of the sleeve 213: as can be seen clearly in FIGS. 2 and 3, the inner surface 212A of the female divergent part 212 is centered on the axis X-X while flaring toward the downstream. According to a practical embodiment, implemented in the figures, the inner surface 212A is frustoconical, being centered on the axis X-X and diverging toward the downstream. Herein, the inner surface 212A is smooth throughout.

The sleeve 213 of the casing 210 delimits an inner surface 213A which closes the internal volume of the sleeve 213 all around the axis X-X and by which the internal volume of the female divergent part 212 is connected along the axis X-X with the outside of the casing 210: in the embodiment considered in the figures, the inner surface 213A of the sleeve 213 is cylindrical with a circular base, centered on the axis X-X. Herein, the inner surface 213A extends over the entire axial extent of the sleeve 213 and comes out onto the downstream end 210B of the casing 210, the downstream end 210B being thereby presented by the sleeve 213.

In the embodiment considered herein, and as can be seen clearly in FIGS. 1 and 2, the sleeve 213 includes modular elements 215 which follow one another along the axis X-X. In the example illustrated, there are three modular elements 215. Each of the modular elements 215 internally delimits a corresponding part of the internal volume of the sleeve 213 and thus delimits a corresponding part of the inner surface 213A. In practice, the modular elements 215 are assembled in pairs e.g. by means of fastening collars 216.

Furthermore, it will be noted that the specific features of the outer surface of the casing 210 are not limiting.

In addition to the casing 210, the die 200 includes a core 220. As can be seen in FIGS. 1 and 2, the core 220 has an elongate shape, centered on a geometric axis which, in the assembled state of the extrusion machine 10, coincides with the axis X-X and which will hence be considered thereafter as being the axis X-X. Within the die 200, the core 220 is coaxial with the casing 210, being partially arranged inside the latter, in other words in the internal volume of the casing 210. The core 220 thereby includes two parts following each other along the axis X-X, namely an upstream part 220.1, which extends at least partially inside the casing 210, in other words in the internal volume of the latter, and a downstream part 220.2, which extends entirely outside the casing 210. In the embodiment considered in the figures, the upstream part 220.1 of the core 220 extends essentially inside the casing 210, while emerging downstream from the downstream end 210B of the casing 210.

In any case, the upstream part 220.1 of the core 220 is provided with an outer surface 220A, i.e. a surface oriented radially opposite the axis X-X, which extends over the entire axial extent of the upstream part 220.1 of the core 220 and which is arranged both facing, radially to the axis X-X, and coaxially with the inner surface 213A of the sleeve 213 of the casing 210: herein, the outer surface 220A of the core 220 is cylindrical with a circular base, centered on the axis X-X.

In any case, the inner surface 213A of the casing 210 and the outer surface 220A of the core 220 radially delimit therebetween a channel 230 having a cross-section, i.e. a section perpendicularly cutting the axis X-X, which is annular and centered on the axis X-X. The channel 230 thereby extends along the axis X-X from an upstream end 230A of the channel to a downstream end 230B of the channel, the upstream end 230A being axially oriented toward the extruder 100 in the assembled state of the extrusion machine 10. The inner surface 213A of the casing 210 delimits the channel 230 by forming the outer periphery of the channel, from the upstream end 230A to the downstream end 230B of the channel 230. The outer surface 220A of the core 220 delimits the channel 230 by forming the inner periphery of the channel, from the upstream end 230A to the downstream end 230B of the channel. The channel 230 extends continuously around the axis X-X, i.e. over 360°. In service, the material 5 leaving the sleeve 110 flows into the channel 230 to pass through the die 200, advancing in the channel 230 from the upstream end 230A to the downstream end 230B of the channel 230. The flow of material flowing in the channel 230, which is referenced 7 in FIGS. 2 and 3, thereby has an annular shape centered on the axis X-X.

In the embodiment considered in the figures, wherein the inner surface 213A of the casing 210 and the outer surface 220A of the core 220 are each cylindrical with a circular base. It will be understood that the annular cross-section of the channel 230 is constant from the upstream end 230A to the downstream end 230B.

In practice, as shown in FIG. 1, the die 200 comprises a bearing structure 240 on which the casing 210 rests fixedly and which is supported on the ground. The bearing structure 240 is advantageously provided with rollers 241 by which the bearing structure 240 rests on the ground, the rollers 241 making it possible, when the die 200 is not in use, to move the die relative to the ground, e.g. to make possible cleaning, maintenance or successive use with respect to a plurality of extruders. Of course, the embodiment of the bearing structure 240 is not limiting.

Whatever the embodiment thereof, the core 220 is not, unlike the casing 210, provided to be stationary relative to the bearing structure 240 and relative to the sleeve 110 of the extruder 100 in the assembled state of the extrusion machine 10, but is provided to rotate about the axis X-X. Thereby, within the die 200, the core 220 is mounted to rotate about the axis X-X relative to the casing 210. Thereby the outer surface 220A of the core 220 is turning on itself about the axis X-X.

For the purpose of rotating the core 220 about the axis X-X, the die 200 comprises a motor-drive 250 which is coupled to the downstream part 220.2 of the core 220. In practice, the geometrical specific features of the motor-drive 250 are not limiting. As an example, the motor-drive 250 is electric and the drive output thereof is, outside the casing 210, in direct or indirect engagement with the downstream part 220.2 of the core 220. According to a practical layout, which does not appear in the figures, the motor-drive 250 advantageously rests on the bearing structure 240, the fixed components of the motor-drive being fixedly connected to the bearing structure 240.

As an example of a possible embodiment of the core 220, which is implemented in the figures, the core 220 comprises a central shaft 221 and a stepping member 222, fixedly secured to each other. The central shaft 221 is centered on the axis X-X and an upstream part of the central shaft 221, which belongs to the upstream part 220.1 of the core 220, is arranged inside the casing 210, whereas a downstream part of the central shaft 221, belonging to the downstream part 220.2 of the core 220, is situated outside the casing 210 where the downstream part of the central shaft is coupled to the motor-drive 250. The stepping member 222 belongs to the upstream part 220.1 of the core 220 and is arranged essentially inside the casing 210, being fixedly secured to the upstream part of the central shaft 221. The stepping member 222 delimits the outer surface 220A.

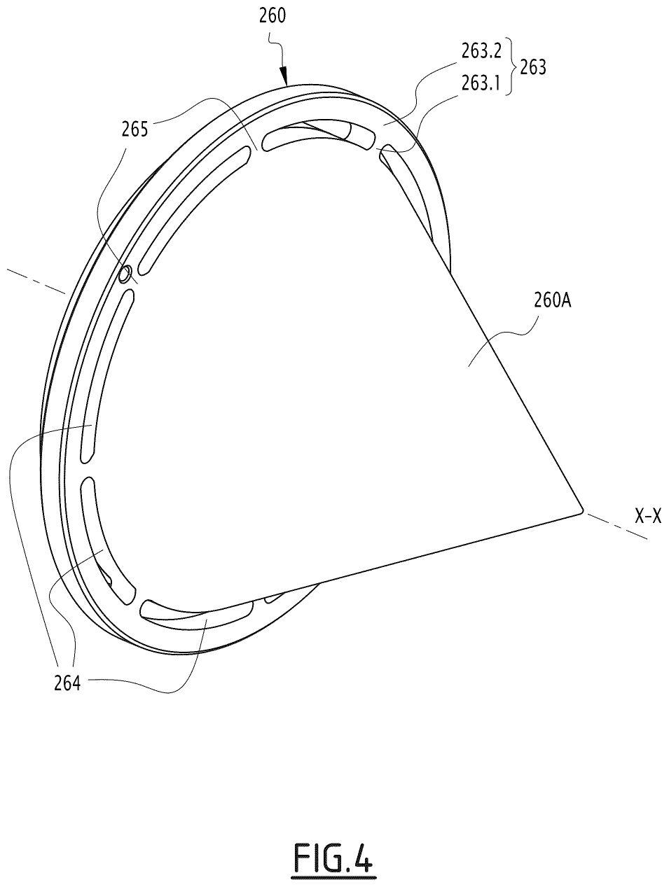

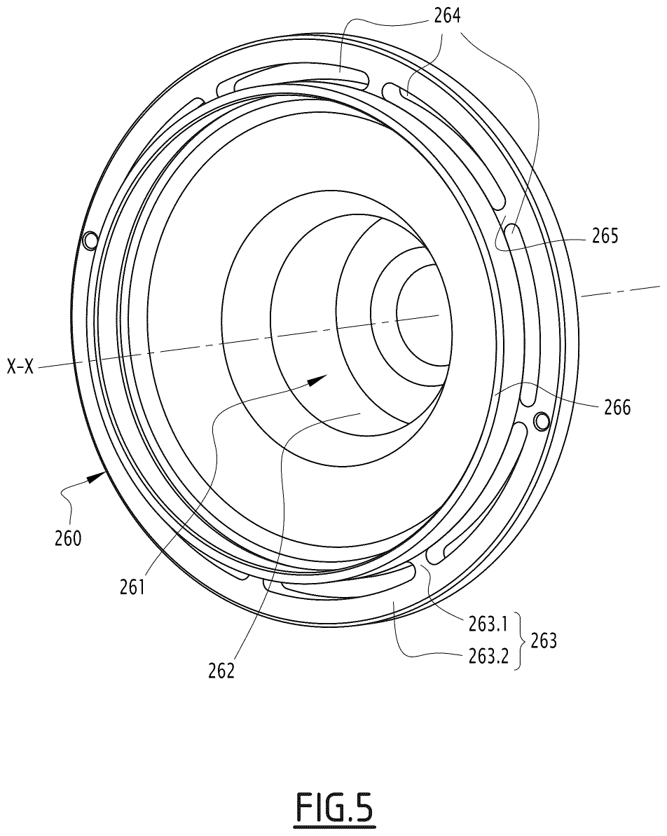

As can be seen clearly in FIGS. 2 and 3, the die 200 further includes a male divergent part 260 which is shown alone in FIGS. 4 and 5. Within the die 200, the male divergent part 260 is arranged coaxially inside the casing 210, more precisely essentially in the internal volume of the casing 210, and is situated both immediately upstream of the core 220 and downstream of the central inlet 211.

As can be seen clearly in FIGS. 4 and 5, the male divergent part 260 is in the form of an Asian conical hat, centered on the axis X-X. Thereby, as can be seen clearly in FIG. 4, on the upstream side thereof, i.e. the axial side thereof oriented toward the central inlet 211, the male divergent part 260 flares progressively downstream, from a pointed upstream end of the male divergent part 260, centered on the axis X-X: in the embodiment considered herein, the male divergent part 260 delimits, on the upstream side thereof, an outer surface 260A which is conical being centered on the axis X-X and diverging towards the downstream. In the example envisaged in the figures, the outer surface 260A is smooth throughout, as clearly visible in FIG. 4. As clearly visible in FIG. 5, on the downstream side thereof, i.e. the axial side thereof oriented opposite the central inlet 211, the male divergent part 260 is hollow and delimits an internal housing 261 which is centered on the axis X-X and which emerges axially on the downstream side of the male divergent part 260. The internal housing 261 does not emerge onto the outer surface 260A which is completely separated from the internal housing 261 by a solid wall 262 of the male divergent part 260, which wall is generally conical and which delimits the internal housing 261. In the embodiment considered herein, the internal housing 261 is advantageously stepped with respect to the axis X-X.

According to an advantageous aspect, the interest of which will become apparent later, the male divergent part 260 is provided with a peripheral flange 263 which is centered on the axis X-X and which encircles the axis X-X. As can be seen clearly in FIGS. 4 and 5, the peripheral flange 263 extends from the solid wall 262, protruding radially from the outer surface 260A. Herein, the peripheral flange 263 is located axially at the downstream end of the male divergent part 260, in other words at the axial level where the solid wall 262 has the largest outside diameter thereof. In any case, as can be seen clearly in FIGS. 4 and 5, the peripheral flange 263 is provided with apertures 264 which each pass axially all the way through the peripheral flange 263, more precisely an inner part 263.1 of the latter, i.e. a part oriented toward the axis X-X. The apertures 264 are distributed around the axis X-X, advantageously in a regular manner. Herein, the apertures 264 each have an arcuate profile centered on the axis X-X. Between the two apertures 264 of each pair of apertures adjacent to one another about the axis X-X, the peripheral flange 263 includes a lug 265 which, about the axis X-X, separates the two apertures of the pair of apertures in question from one another and which, radially to the axis X-X, connects to the wall 262, an outer part 263.2 of the peripheral flange 263, surrounding the apertures 264 externally.

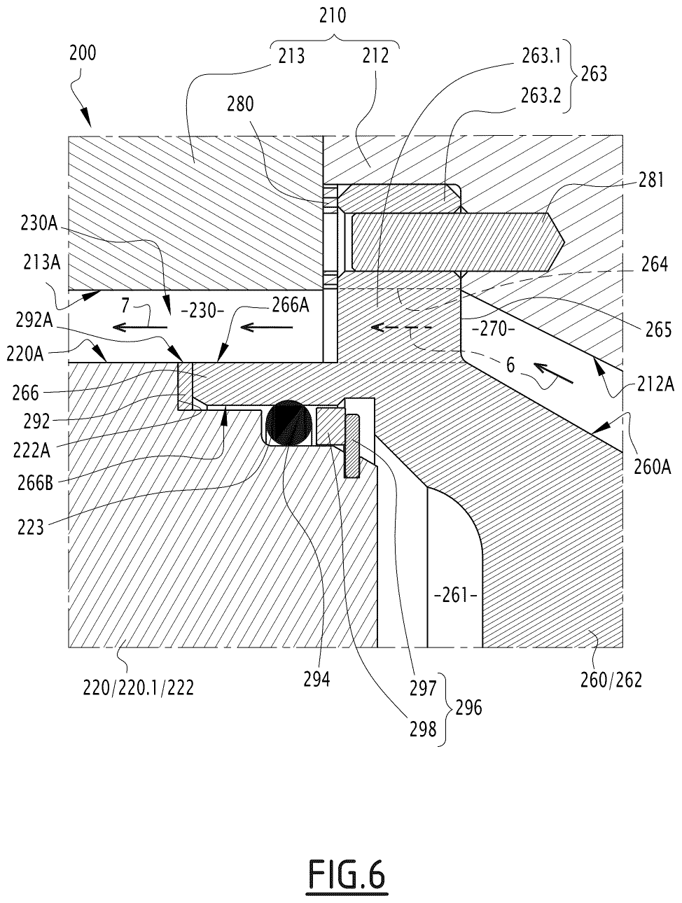

According to another advantageous aspect, the interest of which will also appear later, the male divergent part 260 includes, at the downstream end thereof, a ring 266, or cylindrical protuberance, which is centered on the axis X-X and which extends axially protruding downstream from the solid wall 262, more precisely from the downstream axial edge of the solid wall. As can be seen clearly in FIGS. 5 and 6, the ring 266 is inscribed inside the inner contour of the peripheral flange 263 and is provided with an outer surface 266A which is herein both cylindrical with a circular base, centered on the axis X-X, and flush with the respective edges of the apertures 264, radially oriented toward the axis X-X.

As can be seen clearly in FIGS. 2, 3 and 6, the male divergent part 260 is, within the die 200, fixedly secured to the casing 210, being received in the internal volume of the casing 210, so that, between the male divergent part 260 and the casing 210, a passage 270 is delimited, by which the central inlet 211 of the casing 210 and the upstream end 230A of the channel 230 are connected to each other. In the embodiment considered herein, the male divergent part 260 is thereby essentially housed inside the female divergent part 212 of the casing 210 and the passage 270 is essentially delimited between the inner surface 212A of the female divergent part 212 and the outer surface 260A of the male divergent part 260: the material pushed through the die 200 advances in the passage 270, from the central inlet 211 toward the upstream end 230A of the channel 230, forming a flow of material 6 of overall frustoconical shape, centered on the axis X-X and diverging toward the downstream. More generally, the passage 270 delimited between the male divergent part 260 and the casing 210 is shaped in such a way that the flow of material 6 formed by the material advancing in the passage 270 from the central inlet 211 of the casing 210 to the upstream end 230A of the channel 230 diverges from the axis X-X toward the downstream and is distributed around the axis X-X. The passage 270 thereby serves to make annular the cylindrical flow of the material 5 entering the die 200.

In the embodiment considered herein, the fixed securing between the male divergent part 260 and the casing 210 is advantageously achieved by the peripheral flange 263 of the male divergent part 260. The peripheral flange 263 is preferentially attached to the casing 210 by axially catching the peripheral flange 263, in particular the outer part 263.2 of the latter, between the female divergent part 212 and the sleeve 213 of the casing 210, advantageously with axial interposition of a sealing gasket 280, as clearly visible in FIG. 6. To this end, one and/or the other of the female divergent part 212 and the sleeve 213 are provided with a peripheral groove wherein the peripheral flange 263 is assembled by means of a recess, as clearly visible in FIG. 6. The attachment between the peripheral flange 263 and the casing 210 is advantageously reinforced by one or a plurality of studs 281 which are attached axially through the peripheral flange 263, more particularly the outer part 263.2 thereof, and which serve to improve both the positioning transversely to the axis X-X and the locking in rotation about the axis X-X between the peripheral flange 263 and the casing 210.

It should be understood that, in the embodiment considered in the figures, the peripheral flange 263, more particularly the inner part 263.1 thereof, is located on the passage 270, extending transversely to the axis X-X, across the flow of material 6 flowing through the passage 270. Given the above, the apertures 264 allow the peripheral flange 263 to be traversed by the passage 270, in the direction wherein the peripheral flange 263 can be crossed by the flow of material 6 via the apertures 264, as indicated by dashed lines in FIG. 6. It should be thus understood that the flow section of the apertures 264 is preferentially as large as possible.

More generally, in the continuation of the considerations just hereinabove, it should be understood that the passage 270 is designed to pass through one and/or the other of parts, which belong to the male divergent part 260 and to the casing 210, respectively, and by which the male divergent part 260 is fixedly secured to the casing 210. To this end, one and/or the other of the two aforementioned parts belonging to the male divergent part 260 and to the casing 210, respectively, are perforated from one side to the other by one or a plurality of apertures functionally analogous to the apertures 264 which, in the example illustrated in the figures, each pass axially all the way through the peripheral flange 263: the aperture or the apertures allow the flow of material 6 flowing through the passage 270 to pass through the two aforementioned parts belonging to the male divergent part 260 and to the casing 210, respectively.

In any case, since the male divergent part 260 is fixedly secured to the casing 210, the core 220 can rotate about the axis X-X with respect to the male divergent part 260. As can be seen clearly in FIGS. 2 and 3, with respect to the core 220, the male divergent part 260 abuts axially against the upstream part 220.1 of the core 220, supporting and guiding the core 220 in rotation, outside the passage 270. To this end, in the embodiment considered herein, the upstream part 220.1 of the core 220, more particularly an upstream end of the central shaft 221, is partially received in the internal housing 261 of the male divergent part 260, being supported therein and guided in rotation by the solid wall 262 which separates the internal housing 261 from the passage 270. The internal housing 261 being stepped herein, a bearing 290, in particular a plain bearing, is advantageously interposed radially between the upstream part 220.1 of the core 220, more particularly the aforementioned upstream end of the central shaft 221, and the solid wall 262 of the male divergent part 260.

In practice, as can be seen clearly in FIG. 6, a sliding washer 292 is advantageously interposed axially between the male divergent part 260 and the upstream part 220.1 of the core 220: the washer 292 makes it possible to uncouple the rotation of the male divergent part 260 and of the core 220 from each other. Herein, the sliding washer 292 is interposed axially between an upstream end shoulder 222A of the stepping member 222 of the core 220, extending radially inwardly from the outer surface 220A of the upstream part 220.1 of the core 220, and the ring 266 of the male divergent part 260, while providing that the outer surface 266A of the ring 266 and an outer surface 292A of the sliding washer 292 are flush with the outer surface 220A of the upstream part 220.1 of the core 220: in this way, the rotating uncoupling between the male divergent part 260 and the core 220 is effective, without leading to head losses, nor disturbances in the flow of the material through the upstream end 230A of the channel 230.

In addition, in order to seal the rotating uncoupling between the male divergent part 260 and the core 220 and thereby prevent any substantial leakage of the material passing through the die 200, the latter advantageously includes a sealing member 294 which is more particularly visible in FIG. 6. In practice, the embodiment of the sealing member is not limiting, since the sealing member 294 thereby can comprise only one O-ring, as illustrated in the figures, as well as a plurality of O-rings and/or a four-lobe seal and/or a mechanical seal and/or etc. In any case, as clearly visible in FIG. 6, the sealing member 294 is received in a peripheral groove 223 of the upstream part 220.1 of the core 220, the peripheral groove 223 being delimited herein at an upstream end of the stepping member 222. In addition, the sealing member 294 is applied radially against the ring 266 of the male divergent part 260, more precisely against an inner surface 266B of the ring 266. To facilitate the cleaning of the peripheral groove 223 and/or the maintenance of the sealing member 294, the groove 223 is delimited axially by a dedicated member 296 which is advantageously removably directly mounted onto the upstream part 220.1 of the core 220: herein, as clearly visible in FIG. 6, the dedicated member 296 includes a stop ring 297, retained axially on the stepping member 222 of the core 220, and a sliding washer 298, interposed axially between the stop ring 297 and the sealing member 294.

Of course, the embodiment of the sealing member 294, discussed in detail hereinabove, is specific to the example illustrated in the figures. It should be understood that, more generally, the die 200 advantageously comprises a sealing member, such as the sealing member 294, designed to seal the rotating uncoupling mechanical interface between the male divergent part 260 and the core 220.

The operation of the extrusion machine 10 will now be described.

The ingredients of the raw material 3 are inserted into the sleeve 110, then are pulled along downstream by the screws 120, while being transformed under the effect of the thermomechanical processing applied by the sleeve and the screws. The material 5 leaving the sleeve 110 is pushed, by the screws 120, through the die 200, entering the latter via the central inlet 211 and flowing into the die 200 successively through the passage 270 and through the channel 230.

In the passage 270, the material forming the flow of material 6 is distributed all around the axis X-X, while moving away from the axis X-X toward the downstream, to reach the upstream end 230A of the channel 230. The hydrostatic thrust of the flow of material 6 generates axial stresses on the male divergent part 260, which are transmitted integrally to the casing 210 and, thereby, to the bearing structure 240, without passing through the core 220.

In the channel 230, the material forms the flow of material 7 and flows from the upstream end 230A to the downstream end 230B of the channel 230, where the material exits outside the casing 210 to form the food product 1. The material of the flow of material 7 is sheared, progressively as same flows through the channel 230, because the core 220 is rotated about the axis X-X by the motor-drive 250, the flow of material 7 thereby winding in a helix about the axis X-X toward the downstream. The technical considerations relating to the shear are explained in detail in WO 2022/018084 and WO 2023/006713 to which the reader may usefully refer. In any case, the fibration of the material of the flow of material 7, resulting from the shearing, is controlled due, in particular, to the positioning and the guiding in rotation of the core 220 with respect to the casing 210 by means of the male divergent part 260.

It should be noted that, at the apertures 264 through which the flow of material 6 passes through the peripheral flange 263 during the flow thereof through the passage 270, the flow of material 6 is locally interrupted, about the axis X-X, by the lugs 265. In other words, the lugs 265 form pointlike obstacles for the flow of material 6, which are located herein just upstream of the end 230A of the channel 230. It should be understood that the flow of material 6, which is subdivided by cutting, by crossing the peripheral flange 263 to circumvent the lugs 265, tends to merge all around the axis X-X downstream of the lugs 265. Henceforth, the die 200 makes it possible, to a certain extent, to take advantage of such situation. Indeed, insofar as the flow of material 7 can be controlled so as to wind helically about the axis X-X toward the downstream, by means of the control of the motor-drive 250, the merging of the flow of material downstream of the lugs 265 is easy to control in the flow of material 7, by acting on the speed of rotation of the core 220. It is thereby possible, within the rheological limits of the material actually extruded and depending upon, on the one hand, the operating parameters of the die 200, more particularly the speed of rotation of the core 220 and, on the other hand, of the dimensioning of the lugs 265, to obtain at the outlet of the channel 230 both a completely homogeneous flow of material around the axis, i.e. without perceptible trace of the passage of the peripheral 263, as well as a flow of material integrating cut-out lines, marked to a greater or lesser extent, resulting from the presence of the lugs 265.

In the immediate extension of the foregoing, it should be noted that the shape of the lugs 265 is not limited to the shape of the example illustrated in the figures. On the contrary, it should be understood that multiple geometries can be envisaged for the lugs 265. Such geometries make it possible in particular to mark the aforementioned cut-out lines to a greater or lesser extent. Such geometries also make it possible, where appropriate, to participate in hygiene considerations, depending on the influence thereof on the ease of cleaning of the lugs 265 and/or on the accumulation/discharge of material at the lugs 265. As non-limiting examples, rather than, as in the example illustrated in the figures, each of the lugs 265 has, on the upstream side thereof, a flat facet inscribed in a geometric plane perpendicular to the axis X-X, each of the lugs 265 may be shaped in a pointed or domed manner in the upstream direction, by flaring progressively toward the downstream, in particular in the manner of a bow of a boat. The invention encompasses such various geometries for the lugs 265.

Finally, various fittings and variants of the extrusion machine 10 described up to now, are conceivable. As examples, we list hereinafter are various corresponding aspects, which can be considered alone together with the foregoing or in combination with each other:

Rather than being completely smooth as in the example illustrated in the figures, the outer surface 260A of the male divergent part 260 and/or the inner surface 212A of the female divergent part 212 may have a non-smooth surface state, in particular for acting on the flow of the material 6 progressively as the latter advances in the passage 270, diverging from the axis X-X toward the downstream and being distributed around the axis X-X. Thereby, the outer surface 260A and/or the inner surface 212A can be in particular provided, for one or for the other, with protruding ribs which extend each lengthwise parallel to the axis X-X or inclined relative to the axis X-X or else winding about the axis X-X. Such ribs can, where appropriate, join the lugs 265 and thereby participate in a pre-orientation of the material with regard to the aforementioned cut-out lines.

As mentioned hereinabove, rather than by the peripheral flange 263, the fixed securing between the male divergent part 260 and the casing 210 can be achieved by various fittings, such as a bolting of the male divergent part 260 onto the female divergent part 212.

Unlike what is schematically illustrated in FIGS. 1 and 2, the inner surface 220A of the core 220 may emerge slightly, toward the downstream, from the downstream end 210B of the casing 210 and/or may be continued toward the downstream by an outlet deflector so as to exert a back pressure with respect to the flow of the material leaving the channel 230. In this respect, the reader may usefully refer to WO 2022/018084 and WO 2023/006713.

The core 220 can be equipped with a tool for breaking up the material leaving the casing 210, the breaking up tool taking advantage of the rotation of the core 220 to act on the food product 1 at the exit thereof from the channel 230.

The core 220 may include a plurality of successive modules along the axis X-X, as taught in WO 2022/018084 and WO 2023/006173 to which the reader may refer in this respect.

Rather than being cylindrical with a circular base, one and/or the other of the inner surface 213A of the casing 210 and of the outer surface 220A of the core 220 may be frustoconical, being centered on the axis X-X and diverging toward the downstream, as explained in detail in WO 2023/006173 to which the reader may refer for further details.

Whatever the embodiment of the casing 210 and of the core 220, one and/or the other of the casing 210 and the upstream part 220.1 of the core 220 can be thermoregulated, i.e. each designed to control the temperature thereof so as, at least locally, to maintain same at a determined value advantageously adjustable, despite the heat exchanges with the immediate environment thereof. In this way, the casing 210 and/or the upstream part 220.1 of the core 220 can act on the temperature in the channel 230, more precisely on the temperature of the flow of material 7, by means of a heat exchange with the material through the inner surface 213A and the outer surface 220A, respectively. Practical details relating to such thermoregulation are given in WO 2022/018084 and WO 2023/006713 to which the reader may usefully refer. Of course, the thermoregulation of the casing 210 encompasses the potential thermoregulation of the female divergent part 212. As for the male divergent part 260, the thermoregulation thereof is optionally conceivable, either from the casing 210 via fittings dedicated to the interface between the upstream part 220.1 of the core 220 and the male divergent part 260, such as rotary seals.

1. A die for extruding a material high in proteins and in water, comprising:
a casing, which is tubular, centered on an axis, and which is provided with a central inlet through which the material enters the interior of the casing to be pushed through the die, and
a core, which is coaxial with the casing and mounted rotatably about the axis relative to the casing,
wherein the core includes an upstream part extending at least partially within the casing such that a channel is delimited between an inner surface of the casing and an outer surface of the core, said channel having a cross-section which is annular and centered on the axis, wherein said channel includes an upstream end and a downstream end which are axially opposed to each other and between which material pushed through the die flows into the channel from the upstream end to the downstream end of the channel, and
wherein the core also includes a downstream part, extending outside the casing and coupled to a motor-drive of the die, suitable for driving the core in rotation about the axis,
wherein the die further includes a male divergent part which is:
fixedly secured to the casing and coaxially received inside the casing in such a way that, between the male divergent part and the casing, a passage is delimited, through which the central inlet of the casing and the upstream end of the channel are connected and which is shaped in such a way that the material pushed through the die flows into the passage, from the central inlet of the casing toward the upstream end of the channel, forming a flow of material which diverges from the axis toward the downstream and is distributed around the axis, and
abutted axially to the upstream part of the core, supporting and guiding the core in rotation.

2. The die according to claim 1 wherein the male divergent part delimits an internal housing, which is separated from the passage and wherein the upstream part of the core is received while being supported and guided in rotation.

3. The die according to claim 2, wherein the die further includes a bearing, which is centered on the axis and which is radially interposed between the upstream part of the core and a wall of the male divergent part, delimiting the internal housing.

4. The die according to claim 1, wherein the passage is delimited by an outer surface of the male divergent part which is conical being centered on the axis and diverging toward the downstream.

5. The die according to claim 1, wherein the casing comprises a die sleeve which delimits said inner surface of the casing, and wherein the casing also includes a female divergent part:
which is fixedly secured to the die sleeve,
which is provided with the central inlet of the casing, and
inside which the male divergent part is fitted coaxially so as to delimit the passage between the female divergent part and the male divergent part.

6. The die according to claim 1, wherein the male divergent part is fixedly secured to the casing by respective parts of the male divergent part and of the casing, one and/or the other of which are perforated in order to be crossed by said flow of material.

7. The die according to claim 1, wherein the male divergent part includes a peripheral flange:
by means of which the male divergent is fixedly secured to the casing,
which extends, transversely to the axis, across said flow of material, and
which is traversed by the passage via apertures in the peripheral flange, which are distributed around the axis and through which said flow of material crosses the peripheral flange.

8. The die according to claim 6, wherein
the male divergent part includes a peripheral flange:
by means of which the male divergent is fixedly secured to the casing,
which extends, transversely to the axis, across said flow of material, and
which is traversed by the passage via apertures in the peripheral flange, which are distributed around the axis and through which said flow of material crosses the peripheral flange; and
the peripheral flange is axially caught between the die sleeve and the female divergent part of the casing.

9. The die according to claim 1, wherein the die also includes a sealing member designed to seal a mechanical rotating uncoupling interface between the male divergent part and the core.

10. The die according to claim 9, wherein the sealing member is:
received in a peripheral groove of the upstream part of the core, and
applied radially against a ring of the male diverging part, the ring having an outer surface which is flush with said outer surface of the upstream part of the core.

11. A system for the continuous preparation of an extruded food product, comprising:
a raw material that is rich in proteins and in water,
an extruder including at least one screw and an extruder sleeve inside which the at least one screw can be rotated so as to apply a thermomechanical processing to the raw material, and
the die according to claim 1, the outer casing of which is fixedly secured to the extruder sleeve in such a way that, at the outlet of the extruder sleeve, the material is pushed by said at least one screw through the die via the central inlet of the casing.
